(19) United States
(12) Patent Application Publication
(10) Pub. No.: US 2014/0109861 A1
(43) Pub. Date: Apr. 24, 2014

(54) PISTON AND TRIBOLOGICAL SYSTEM CONSISTING OF A PISTON AND A CYLINDER RUNNING SURFACE OF A CYLINDER CRANK CASE FOR AN INTERNAL COMBUSTION ENGINE

(71) Applicant: MAHLE INTERNATIONAL GMBH, Stuttgart (DE)

(72) Inventors: Stephan Korner, Besigheim (DE); Wolfgang Schlenther, Backnang (DE); Cedric Dobua, Stuttgart (DE)

(73) Assignee: Mahle International GmbH, Stuttgart (DE)

(21) Appl. No.: 13/656,085

(22) Filed: Oct. 19, 2012

(51) Int. Cl. F02F 3/10

(52) U.S. Cl. 123/193.4

(57) ABSTRACT

A piston for an internal combustion engine may include a piston head and a piston skirt. The piston skirt may have piston bosses provided with boss bores. The piston bosses may be connected to each other at running surfaces. The running surfaces may be provided at least partially with a coating which is sprayed using a cold gas method. The material of the coating may be selected from the group comprising at least one of nickel, iron, copper, nickel-based alloys, iron-based alloys, copper-nickel-tin-based alloys and copper-tin-silver-based alloys.

### CROSS-REFERENCES TO RELATED APPLICATION

This application claims priority to German patent application DE 102011084990.4, filed Oct. 21, 2011, which is hereby incorporated by reference in its entirety.

### TECHNICAL FIELD

The present invention relates to a piston for an internal combustion engine, having a piston head and a piston skirt, the piston skirt having piston bosses, which are provided with boss bores and are arranged on the underside of the piston head by means of hub attachments, and the piston bosses being connected to each other by means of running surfaces. The invention further relates to a tribological system consisting of such a piston and a cylinder running surface for an internal combustion engine.

### BACKGROUND

In modern internal combustion engines, the piston is thermally and mechanically loaded to a particular extent. This also applies to the piston skirt and the running surfaces thereof, in particular during tribological interaction between the piston running surface and the cylinder running surface. This results in rapid fatigue of the running surfaces. In order to counteract this fatigue, it is known to provide the running surfaces with a coating which is intended to withstand the mechanical and thermal loads and improve the friction behaviour of the piston with respect to the cylinder running surface.

### SUMMARY

The object of the present invention consists in developing a generic piston and a generic tribological system so that a reduction in fatigue of the coating owing to the thermal and mechanical loading thereof is achieved and the friction in the tribological system is reduced.

A first solution consists in that the running surfaces are provided at least partially with a coating which is sprayed using a cold gas method and that the material of the coating is selected from the group comprising nickel, iron, copper, nickel-based alloys, iron-based alloys, copper-nickel-tin-based alloys and copper-tin-silver-based alloys. A further solution consists in that, in the tribological system consisting of the piston and the cylinder running surface, the cylinder running surface is produced from aluminium alloy.

The concept according to the invention consists in providing a coating which is sprayed using a cold gas method. Owing to the high kinetic energy of the particles impinging on the running surfaces to be coated, they are “wedged” with the substrate thereof, so the coating adheres extremely strongly to the running surface. The coating is oxide-free and very compact. The piston is not heated during the coating process and therefore does not expand. All this has a positive effect on the thermal and mechanical stability of the piston according to the invention. Furthermore, the materials of the coating can have a positive influence on thermal and mechanical stability. Copper and silver in particular have high thermal conductivity and have a particularly positive effect on the thermal stability of the piston according to the invention.

The tribological properties of the tribological system consisting of the piston and the cylinder running surface are also optimised. The wear behaviour is improved and the friction is reduced. The coating sprayed using the cold gas method can be built up in a variable manner, for example as an alloy coating, sandwich coating or gradient coating. The composition of the coating can be varied without problems. The tribological properties of the coating can thus be adapted optimally to the requirements of the individual case. Nickel and iron in particular improve the wear resistance, while molybdenum reduces the adhesive wear. Silver and tin have a positive effect on the sliding properties of the piston according to the invention. Copper and nickel also improve the ductility of the coating of the piston according to the invention.

If required, coatings can be created with a greater layer thickness. The roughness of the coating can be set individually and thus adapted optimally to the tribological system according to the invention.

The piston according to the invention and the tribological system according to the invention are simple and can be produced cost-effectively in one process step, it not being absolutely necessary to pre-clean the running surface to be coated.

A further aspect of the present invention consists in that the piston according to the invention with a cylinder running surface consisting of an aluminium alloy produces an optimised tribological system having excellent sliding properties, greatly reduced wear and greatly reduced friction.

Advantageous developments of the invention can be found in the subclaims.

Coatings consisting of a nickel-iron-based or nickel-iron-molybdenum-based or iron-nickel-molybdenum-based or iron-nickel-copper-based alloy have particularly good stability and excellent tribological properties.

The roughness Ra of the coating can in particular be varied within a range from 0.5 μm to 4.0 μm, while the layer thickness can in particular be varied within a range from 100 μm to 300 μm.

If the coating is produced from a powder sprayed using the cold gas method and having a grain size of 15 μm to 25 μm, a particularly compact, dense and homogeneous coating is obtained.

The coating can contain at least one solid lubricant to optimise the sliding properties and reduce friction further. Suitable solid lubricants are for example polytetrafluoroethylene, polyvinyl chloride, metal sulphides, in particular MoS₂ and WS₂, graphite and hexagonal boron nitride.

### BRIEF DESCRIPTION OF THE DRAWINGS

Exemplary embodiments of the present invention are explained in more detail below using the attached drawings. In the figures, schematically and not to scale,

FIG. 1 shows an exemplary embodiment of a tribological system according to the invention having a piston according to the invention,

FIG. 2 shows a schematic diagram of the cold gas spraying process.

### DETAILED DESCRIPTION

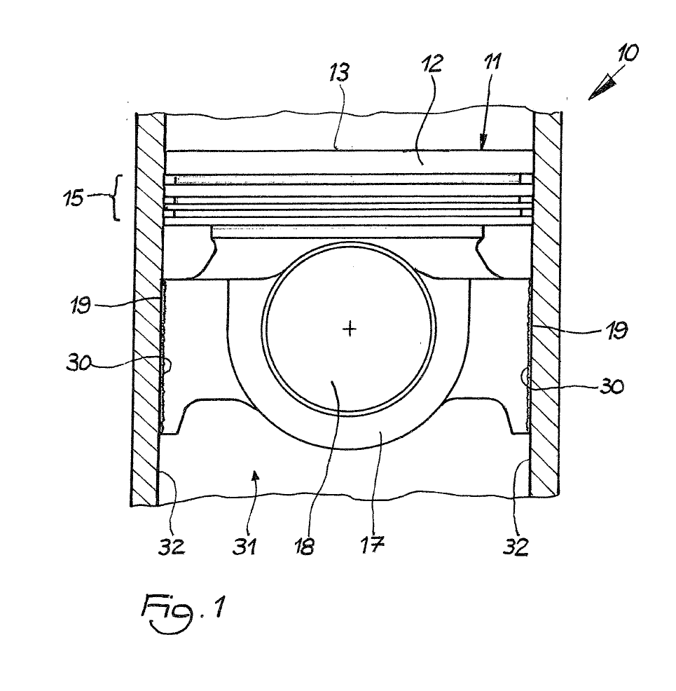

FIG. 1 shows an exemplary embodiment of a tribological system 10 according to the invention having a piston 11 according to the invention. The piston 11 can be a single-part or multi-part piston. The piston 11 can be produced from a steel material and/or a lightweight metal material. FIG. 1 shows a single-part piston 11 by way of example. The piston 11 has a piston head 12 having a piston crown 13, a circumferential top land 14 and a ring portion 15 for receiving piston rings (not shown). The piston 10 also has a piston skirt 16, which is thermally decoupled in the exemplary embodiment, having piston bosses 17 and boss bores 18 for receiving a piston pin (not shown). The piston bosses 17 are connected to each other by means of running surfaces 19. The running surfaces 19 are provided with a coating 30 according to the invention.

The piston 11 according to the invention with the running surface 19 forms the tribological system 10 together with a running surface 32 of a cylinder bore or a cylinder liner 31 of a cylinder crank case (not shown).

The running surface 32, which can be arranged in the cylinder itself or on a cylinder liner 31, consists of an aluminium alloy, for example of AlSi (LOKASIL), AlSi17Cu4Mg (ALUISIL) or of a GJL liner (grey cast iron with lamellar cast iron).

The coating 30 for a running surface 19 has the compositions given in Table 1 in the exemplary embodiment:

TABLE 1
Coatings 30 for a piston 16 consisting of AlSi12Cu3Ni2Mg or AlSi12Cu4Ni2Mg

| Coating | A | B | C | D |
|---|---|---|---|---|
| (Composition) | (Ni51Fe49) | (Ni18.5Fe79Mo2.5) | (CuSn6Ag.06) | (Cu50Ni20Sn30) |
| Positively influenced | Nickel: | Nickel: | Copper: | Copper: |
| properties of the | Oil wettability, | Very good oil | High ductility. Very | High ductility. Very |
| coating | Ductility, very good | wettability → | good corrosion | good corrosion |
| | corrosion protection | hydrodynamic | protection | protection |
| | from alkalis/acids, | lubricant film → | Tin: | Nickel: |
| | very good mechanical | friction optimisation, | Very good corrosion | Oil wettability, |
| | processing | good corrosion | protection from | Ductility, very |
| | Iron: | protection | alkalis/acids, | good corrosion |
| | Very good wear | Iron: | Sliding properties | protection from |
| | resistance | Very good wear | Silver: | alkalis/acids, very |
| | Very good properties | resistance | Very good thermal | good mechanical |
| | with respect to | Very good properties | conductivity → | processing |
| | abrasive/adhesive | with respect to | Reduction of hot spots | Tin: |
| | wear, | abrasive/adhesive | (heat dissipation), | Very good |
| | Very hard layer | wear, | Very ductile | corrosion |
| | Very high | Very hard layer | | protection from |
| | microhardness | Very high | | alkalis/acids, |
| | | microhardness | | Sliding properties |
| | | Molybdenum: | | |
| | | Has excellent | | |
| | | corrosion protection | | |
| | | effects (comparable | | |
| | | with chromium). | | |
| | | Molybdenum has | | |
| | | certain lubricant | | |
| | | properties | | |

| Possible lubricant | | |
|---|---|---|
| particles in coatings A, | | |
| B, C, D: | | Possible in all coatings 30 (A, B, C, D) |
| 1.) | Encapsulated | Coating only possible if the lubricant particles 1.) and 3.) are connected to the matrix |
| | PTFE | (encapsulated). |
| 2.) | PVC | The remaining lubricants can be worked into the matrix as a homogeneous mixture (alloy). |
| 3.) | MoS₂ | |
| 4.) | WS₂ | |
| 5.) | (h)BN hexagonal | |
| | boron nitride | |

The cylinder running surface 32 can be combined with each individual coating 30 (A, B, C, D), that is, with a piston 11 with any coating 30 (A, B, C, D). If grey cast iron liners are combined with the respective coatings 30 (A, B, C, D), the effect of the friction optimisation is further improved, as the lamellar grey cast iron already has a lubricant effect.

In this case the coating B (Ni18.5Fe79Mo2.5) achieves the best properties with regard to wear and friction coefficient. In relation to an uncoated piston skirt 16, wear could be improved by 50% and the friction coefficient could be improved by 60%.

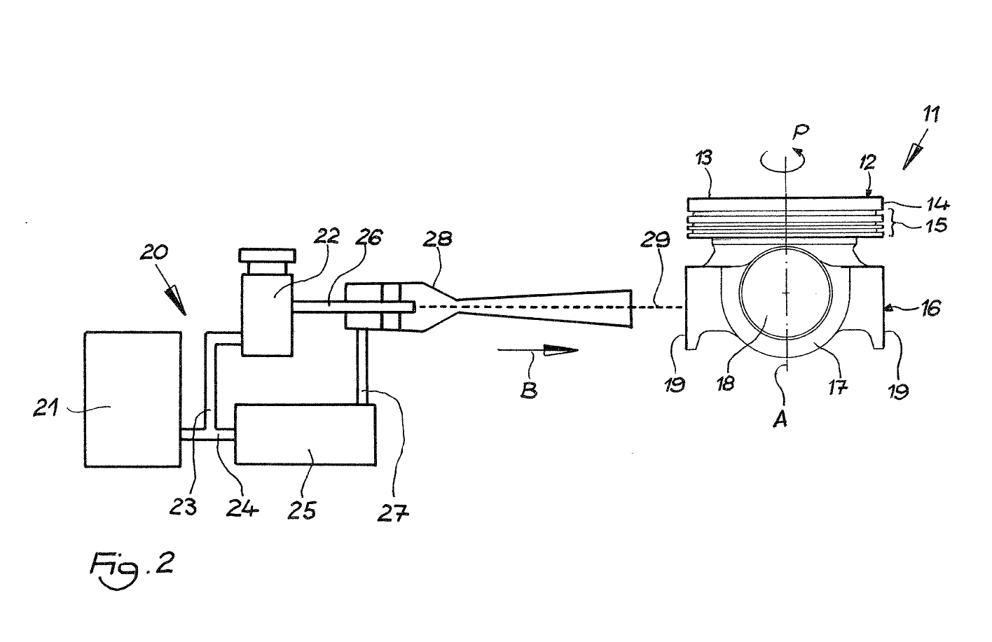

FIG. 2 schematically shows the method for producing the piston according to the invention.

The cold gas spraying process is used to produce the coating 30. The coating 30 can be applied both to an end-processed piston 11 and to a pre-processed piston. It is not absolutely necessary to clean the piston 11 before the coating 30 is applied. The piston 11 can even be smeared with oil or piston lubricants.

The piston 11 to be processed consists of AlSi12Cu3Ni2Mg or AlSi12Cu4Ni2Mg in the exemplary embodiment. A device 20 for cold gas spraying comprises, in a known manner, a storage container 21 for a gas, for example nitrogen, which acts both as a process gas and as a carrier gas for the pulverulent material. The materials used in the exemplary embodiment can be found in Table 1. The material is stored in a powder conveyor 22. A pipeline 23 leads from the storage container 21 to the powder conveyor. The gas transported via this pipeline 23 to the powder conveyor 22 acts as a carrier gas for the pulverulent material. A further pipeline 24 leads from the storage container 21 to a gas heater 25. The gas transported into this gas heater 25 acts as a process gas, which can be heated to a temperature of for example 200-600° C. as required. Both the carrier gas with the pulverulent material and the process gas are transported via pipelines 26, 27 into a supersonic nozzle or Laval nozzle 28. There, the powder/gas mixture is accelerated in the direction of the arrow B, that is, in the direction towards the surface to be coated, i.e. towards the running surface 19 of the piston 11 in the exemplary embodiment, to a speed of more than 500 m/s, at peaks up to 1500 m/s. The resulting jet 29 impinges the running surface 19 to be coated at working distances of typically 5-50 mm and forms the coating 30 in a defined thickness of for example 100 μm to 300 μm and with an axial height H which can be controlled precisely by means of the width of the jet 29. In the process, the piston 11 rotates about its central axis A in the direction of the arrow P. If required, a mask can be applied to the running surface 19 of the piston 11, if only partial coating of the running surface 19 is desired.

1. A piston for an internal combustion engine, comprising:
a piston head and a piston skirt, wherein the piston skirt has piston bosses provided with boss bores and the piston bosses are connected to each other at running surfaces,
further wherein the running surfaces are provided at least partially with a coating which is sprayed using a cold gas method and that the material of the coating is selected from the group comprising at least one of nickel, iron, copper, nickel-based alloys, iron-based alloys, copper-nickel-tin-based alloys and copper-tin-silver-based alloys;
further wherein the running surfaces are configured to form a tribological system together with an opposing running surface of a cylinder bore that is provided with another coating.

2. The piston according to claim 1, wherein the coating is produced from at least one of a nickel-iron-based alloy, nickel-iron-molybdenum-based alloy, iron-nickel-molybdenum-based alloy, and iron-nickel-copper-based alloy.

3. (canceled)

4. (canceled)

5. The piston according to claim 1, wherein the coating has at least one of the following compositions: Ni51Fe49, Ni18.5Fe79Mo2.5, CuSn6Ag.06 and Cu50Ni20Sn30.

6. The piston according to claim 1, wherein the coating contains at least one solid lubricant.

7. The piston according to claim 6, wherein the at least one solid lubricant is selected from the group comprising polytetrafluoroethylene, polyvinyl chloride, metal sulphides, in particular MoS₂ and WS₂, graphite, and hexagonal boron nitride.

8-20. (canceled)

21. A piston for an internal combustion engine, comprising:
a piston head and a piston skirt, wherein the piston skirt has piston bosses provided with boss bores and the piston bosses are connected to each other at running surfaces,
further wherein the running surfaces are provided at least partially with a coating which is sprayed using a cold gas method and that the material of the coating is selected from the group comprising at least one of nickel, iron, copper, nickel-based alloys, iron-based alloys, copper-nickel-tin-based alloys and copper-tin-silver-based alloys;
wherein the coating has a roughness Ra of approximately 0.5 μm to 4.0 μm;
wherein the running surfaces are configured to form a tribological system together with an opposing running surface of a cylinder bore that is provided with another coating.

22. The piston according to claim 21, wherein the coating is produced from at least one of a nickel-iron-based alloy, nickel-iron-molybdenum-based alloy, iron-nickel-molybdenum-based alloy, and iron-nickel-copper-based alloy.

23. The piston according to claim 21, wherein the coating has at least one of the following compositions: Ni51Fe49, Ni18.5Fe79Mo2.5, CuSn6Ag.06 and Cu50Ni20Sn30.

24. The piston according to claim 21, wherein the coating contains at least one solid lubricant.

25. The piston according to claim 24, wherein the at least one solid lubricant is selected from the group comprising polytetrafluoroethylene, polyvinyl chloride, metal sulphides, in particular MoS₂ and WS₂, graphite, and hexagonal boron nitride.

26. A piston for an internal combustion engine, comprising:
a piston head and a piston skirt, wherein the piston skirt has piston bosses provided with boss bores and the piston bosses are connected to each other at running surfaces,
further wherein the running surfaces are provided at least partially with a coating which is sprayed using a cold gas method and that the material of the coating is selected from the group comprising at least one of nickel, iron, copper, nickel-based alloys, iron-based alloys, copper-nickel-tin-based alloys and copper-tin-silver-based alloys;
wherein the coating has a layer thickness of approximately 100 μm to 300 μm, and wherein the coating is produced from a powder, which is sprayed using the cold gas method and has a grain size of approximately 15 μm to 25 μm;
wherein the running surfaces are configured to form a tribological system together with an opposing running surface of a cylinder bore that is provided with another coating.

27. The piston according to claim 26, wherein the coating is produced from at least one of a nickel-iron-based alloy, nickel-iron-molybdenum-based alloy, iron-nickel-molybdenum-based alloy, and iron-nickel-copper-based alloy.

28. The piston according to claim 26, wherein the coating has at least one of the following compositions: Ni51Fe49, Ni18.5Fe79Mo2.5, CuSn6Ag.06 and Cu50Ni20Sn30.

29. The piston according to claim 26, wherein the coating contains at least one solid lubricant.

30. The piston according to claim 29, wherein the at least one solid lubricant is selected from the group comprising polytetrafluoroethylene, polyvinyl chloride, metal sulphides, in particular MoS₂ and WS₂, graphite, and hexagonal boron nitride.
